(19) United States
(12) Patent Application Publication
(10) Pub. No.: US 2005/0008456 A1
(43) Pub. Date: Jan. 13, 2005

(54) Device for securing a structural element to a panel-like component

(75) Inventors: Ralf Birkelbach, Marburg (DE); Lothar Gens, Bad Berleburg (DE); Peter Hau, Karben (DE); Helmut Messer, Russelsheim (DE); Frank Schlosser, Marburg (DE); Dieter Sobing, Russelsheim (DE); Uwe Stremmel, Bad Berleburg (DE)

Correspondence Address: BANNER & WITCOFF, 1001 G STREET N W, SUITE 1100, WASHINGTON, DC, 20001, US

(73) Assignee: EJOT GmbH & Co. KG, Bad Laasphe (DE)

(21) Appl. No.: 10/869,031

(22) Filed: Jun. 17, 2004

(30) Foreign Application Priority Data
Dec. 9, 2003 (DE) 103 57 450.6
Jun. 18, 2003 (DE) 103 27 579.7

(51) Int. Cl. F16B 21/18

(52) U.S. Cl. 411/526

(57) ABSTRACT

The invention relates to a device for securing a structural element provided with a hole to a panel-like component, said panel-like component being fitted with a stay-bolt onto which can be pressed on the side opposite the component a hollow cylindrical part with a flange, said hollow cylindrical part being able to be received by the hole and having a latching portion, the flange having a diameter greater than the diameter of the hole. A metal part, forming the latching portion and having a plurality of latching lugs, is inserted into the hollow cylindrical part, wherein the hollow cylindrical part has a spring portion which yields to axial pressure and the structural element is provided on its side facing the component with an inwardly directed collar on which rests the hollow cylindrical part with its end opposite the flange when the hollow cylindrical part is in the secured position with the spring portion pressed in.

The invention relates to a device for securing a structural element provided with a hole to a panel-like component, said panel-like component being fitted with a stay-bolt onto which can be pressed on the side opposite the component a hollow cylindrical part with a flange, said hollow cylindrical part being able to be received by the hole and having a latching portion, the flange having a diameter greater than the diameter of the hole.

Such a device containing the aforementioned design is published in DE 196 30 249 C2. The known device is a device for securing an insulation panel to a component. The device has a hollow cylindrical portion which can be pressed axially onto a threaded stay-bolt and which has a flange on one side and radially extendable arms on its other side, with the result that an insulation panel which is to be secured in position is surrounded on its one side by the flange and on its other side by the extendable arms. The hollow cylindrical portion is fixed to the stay-bolt by means of a latching portion which engages the thread of the stay-bolt, thus establishing the connection between the hollow cylindrical portion and, through the stay-bolt, with the panel-like component. In this device, the fixing of the insulation panel in the direction away from the panel-like component is effected exclusively by the flange, the stability of which is therefore of particular importance in this connection. Furthermore, the extendable arms are of relatively complex construction, this making the device especially elaborate as a whole.

The object of the invention is to provide a device for securing a structural element provided with a hole to a panel-like component, said device being of simpler design and being more secure, particularly with regard to the holding forces, the completed, secure attachment of the respective structural element being clearly visible.

The object of the invention is achieved in that a metal part, forming the latching portion and having a plurality of latching lugs, is inserted into the hollow cylindrical part, wherein the hollow cylindrical part has a spring portion which yields to axial pressure and the structural element is provided on its side facing the component with an inwardly directed collar on which rests the hollow cylindrical part with its end opposite the flange when the hollow cylindrical part is in the secured position with the spring portion pressed in.

The design of the latching portion in the form of a metal part provided with a plurality of latching lugs makes it possible for the device to be used in connection with stay-bolts which are provided with threads or just with grooves or, alternatively, with stay-bolts which have a smooth cylindrical surface, because metal parts provided with latching lugs have proved in this connection to be especially resistant to pull-off forces. This is also true in the case of stay-bolts which are provided with thick-layered corrosion-protection coatings which are easily penetrated by the metal latching lugs. The inwardly directed collar on the structural element and the end, facing said collar, of the hollow cylindrical part, which, through the metal part with its latching lugs, is connected especially securely to the stay-bolt, result in a fixing of the structural element which, through the adjoining contact of collar and the respective side of the structural element, guarantees a connection with high pull-off forces, without the flange on the hollow cylindrical part being burdened with a special securing function. However, thanks to its spring portion, which yields to axial pressure, the hollow cylindrical part provides the observer with a visual signal as to whether the hollow cylindrical part has reached its end position, i.e. whether, on the one hand, the stay-bolt is securely seated on the component or whether, on the other hand, the structural element is securely attached to the stay-bolt, because, namely, with hollow cylindrical part and structural element in the secured position, the flange is tightly pressed against the hollow cylindrical part, thus indicating the secure attachment of the structural element to the likewise securely seated stay-bolt.

The metal part may be fixedly embedded in the hollow cylindrical part, this being of advantage particularly if the hollow cylindrical part is of injection-moulded plastic, the metal part being embedded during injection-moulding.

It is also possible for the hollow cylindrical part to be provided with a radial slit into which the metal part is inserted.

The flange on the hollow cylindrical part with its spring portion which resiliently yields to axial pressure ensures that, if using a welding stud as the stay-bolt, the spring force of the spring portion will pull back the welding stud from the panel-like component if the welding stud is inadequately secured, with the result that the flange is able to return to its original curved position, thereby indicating that the secure attachment of the welding stud to the panel-like component has not taken place, i.e. the welded connection is inadequate, this being indicated by the coming-away of the inadequately welded-on welding stud and therefore the yielding of the spring portion on the flange.

In order, during the securing of the structural element, to compensate for a possibly existing tilted position of the welding stud as a result of a manufacturing defect, the slit in the hollow cylindrical part is advantageously of such design that the slit is of such an oversize in relation to the thickness of the metal part that the metal part is able to assume a tilted position which compensates for an oblique position of the welding stud. The oversize of the slit makes it possible for the metal part, if necessary, to assume an oblique position in the region of the over-size of the slit.

Advantageously, the metal part has an anti-rotation means in the slit which accepts the metal part, this ensuring that, particularly in the case of vibrations during the use of the device, the metal part is unable to rotate in relation to the stay-bolt, which might result in the course of time in a certain loosening of the metal part in relation to the stay-bolt.

The latching lugs are advantageously of such design that they are of different lengths. This ensures that the latching lugs clawingly engage the stay-bolt axially in different positions, which is shown by experience to improve the security of the connection between the metal part and the stay-bolt. This is especially true if the stay-bolt is a threaded bolt.

The device also makes it possible to compensate for tolerances to a considerable extent, this allowing the structural element to be attached to the panel-like component with considerable tolerance in the plane of the panel-like component. This is advantageously accomplished in that both the hollow cylindrical part and also the stay-bolt are surrounded with clearance by the hole in the structural element. Thus, the hollow cylindrical part accepting the stay-bolt is situated opposite a considerable clearance in the hole of the structural element, i.e. the structural element is able correspondingly to move in relation to the hollow cylindrical part in the plane of the panel-like component.

In order to seal the region of attachment of the stay-bolt to the panel-like component, the structural element is advantageously provided on its side facing the component with a sealing lip. When the hollow cylindrical part is placed in position and thus the structural element is pressed against the panel-like component, the sealing lip is pressed against the structural element, this resulting in the desired sealing effect.

For the attachment of the device to the stay-bolt, it may be advantageous for the hollow cylindrical part to be provided with a receiving means for a screwing-in tool. This is especially true if the stay-bolt is threaded. However, also if using a stay-bolt with a smooth cylindrical surface, it is especially easy to attach the hollow cylindrical part with the metal part consisting of a plurality of latching lugs when the metal part is screwed onto the stay-bolt. In the case of the use of the device according to the invention, particularly in automobile construction, it is advantageous for both the structural element and also the hollow cylindrical part to be provided with acoustic insulation.

As already mentioned, the stay-bolt may be a bolt with a smooth, cylindrical surface or a bolt with circumferential grooves, wherein the circumferential grooves may be formed by closed circles or, alternatively, by a thread.

For the purpose of the pre-assembly of hollow cylindrical part and structural element, the hollow cylindrical part may be secured to the structural element by a latching means, this guaranteeing the captive securing of the hollow cylindrical part in the structural element.

Advantageously, the spring portion may be in the form of a resiliently yielding bulge of the flange. The pressed-in bulge indicates to the observer that the hollow cylindrical part is in tight contact with the structural element.

Another design of the spring portion consists in that the hollow cylindrical part is provided on its side opposite the flange with one or more spring elements which force the hollow cylindrical part away from the structural element. If the spring elements remain elongated, the distance between the flange and the structural element indicates to the observer that the hollow cylindrical part is not in secure contact with the structural element. The flange may be of either curved or flat design.

Illustrative embodiments of the invention are presented in the drawings, in which:

FIGS. 1a, b and c show an embodiment with metal part injection-moulded into the hollow cylindrical part and with a threaded stay-bolt, FIG. 1a showing the hollow cylindrical part prior to being pressed onto the stay-bolt, FIG. 1b showing the hollow cylindrical part in its half-pressed-on state and FIG. 1c showing the hollow cylindrical part in its fully pressed-on state;

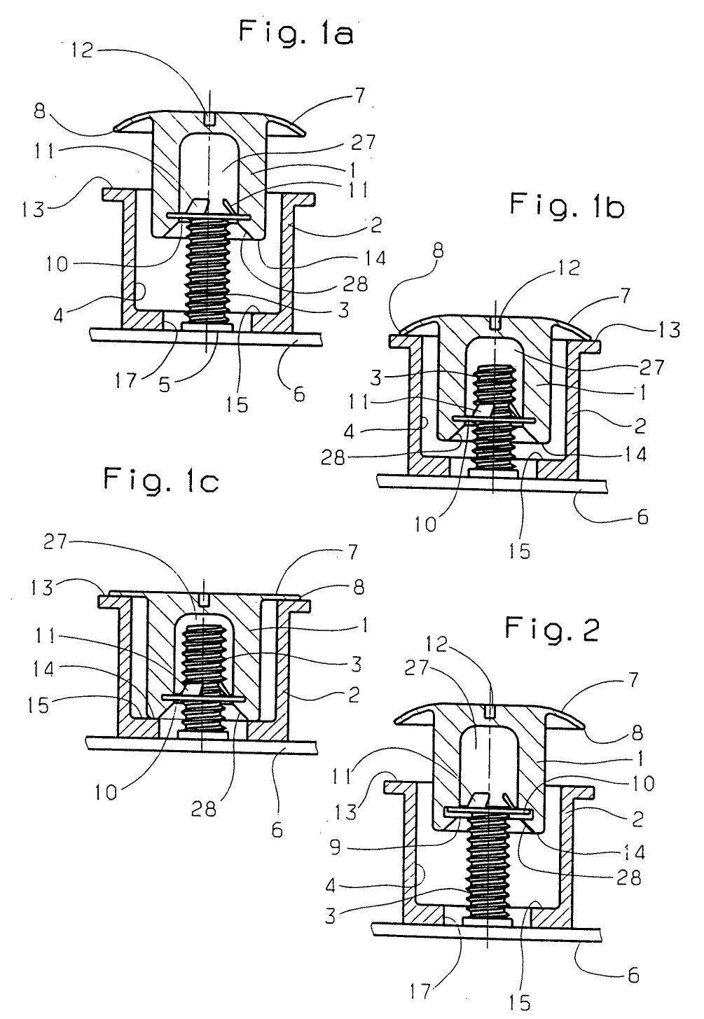

FIG. 2 shows the hollow cylindrical part with a metal part inserted into a slit in a position corresponding to that shown in FIG. 1a;

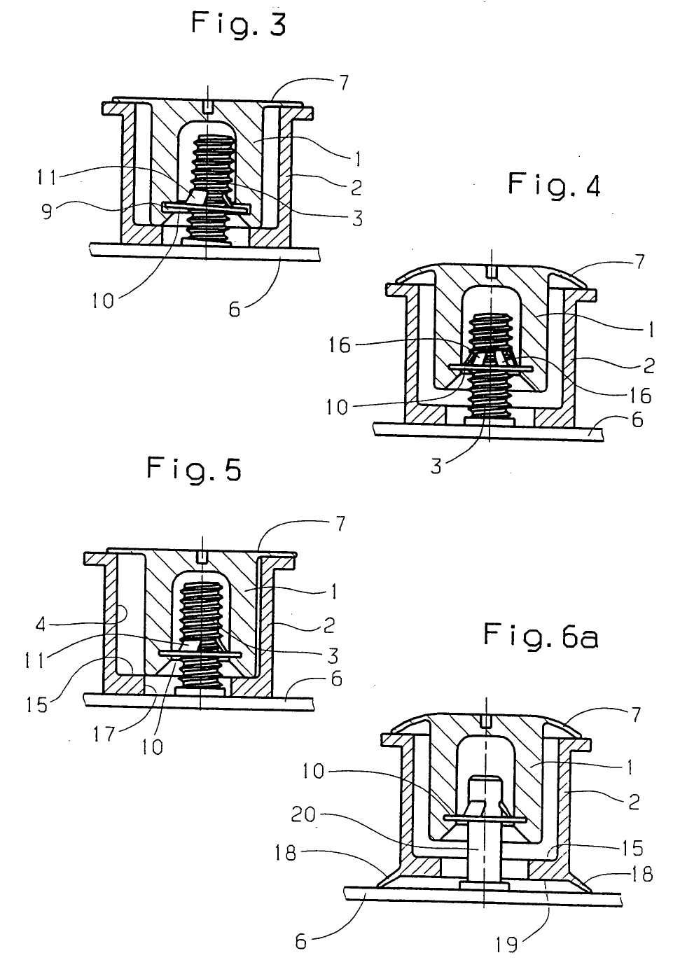

FIG. 3 shows the fully pressed-on device with the stay-bolt in a slightly oblique position;

FIG. 4 shows the device with injection-moulded metal part, said metal part having latching lugs of different lengths;

FIG. 5 shows the device according to FIG. 1 with the hollow cylindrical part in a position in which it is radially displaced with respect to the stay-bolt within the tolerance compensation limits;

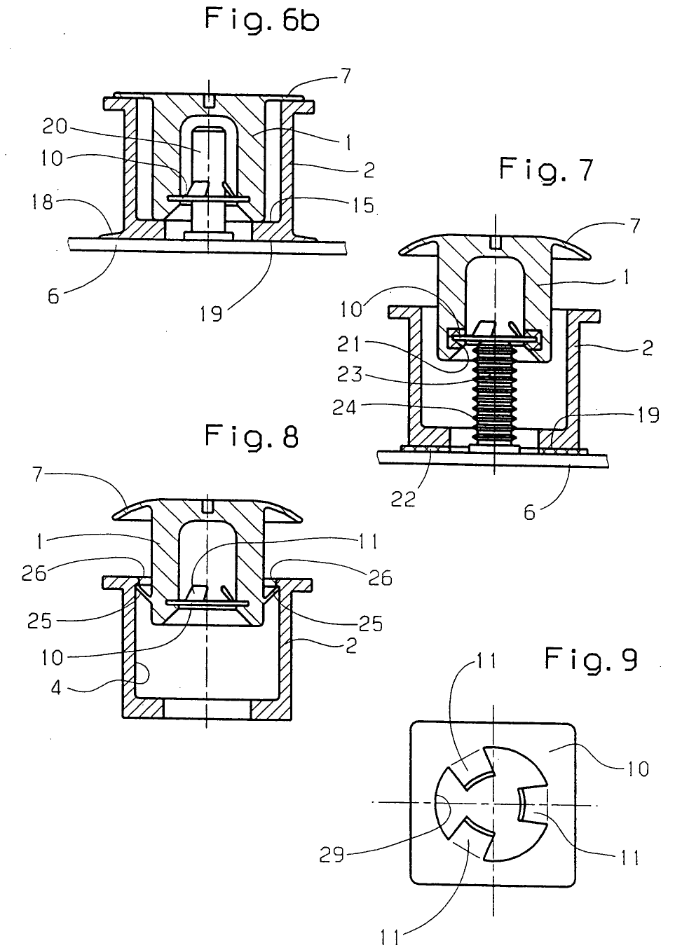

FIGS. 6a and b show the device according to FIG. 1, provided with a sealing lip, FIG. 6a showing the sealing lip in the disengaged state and FIG. 6b showing the sealing lip in the engaged state, the device having been pressed onto a cylindrical stay-bolt;

FIG. 7 shows the device with means for acoustic insulation in the region of the structural element and the hollow cylindrical part using a stay-bolt with circumferential grooves;

FIG. 8 shows the device according to FIG. 1 with a latching means for the captive securing of hollow cylindrical part and structural element;

FIG. 9 shows the metal part on its own in an enlargedview;

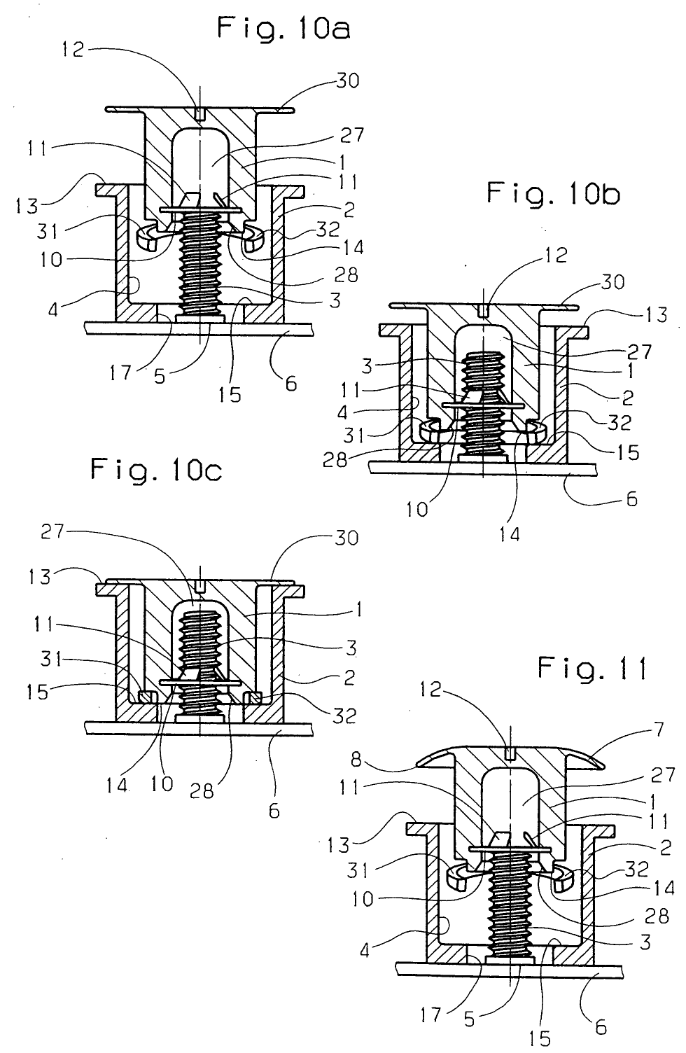

FIGS. 10a, b, c show an embodiment with flat flange and spring elements on the hollow cylindrical part on the side thereof opposite the flange, FIG. 10a showing the hollow cylindrical part prior to being pressed onto the stay-bolt, FIG. 10b showing the hollow cylindrical part in its half-pressed-on state and FIG. 10c showing the hollow cylindrical part in its fully pressed-on state;

FIG. 11 shows an embodiment with curved flange and spring elements on the hollow cylindrical part on the side thereof opposite the flange prior to being pressed onto the stay-bolt.

FIG. 1a presents the device according to the invention, consisting of hollow cylindrical part 1, structural element 2 and stay-bolt 3, with the hollow cylindrical part 1 in its position prior to being pressed onto the stay-bolt 3. For accepting the hollow cylindrical part 1, the structural element 2 has the hole 4, which is oversized to allow the hollow cylindrical part 1 to be accepted. The stay-bolt 3 is in this case a welding stud which is connected via the weld 5 to the panel-like component 6. The panel-like component 6 may be any structural element of, for example, a motor vehicle.

The hollow cylindrical part 1 has on its side opposite the component 6 the flange 7, which is curved and which, because of its material, resiliently yields when pressure is applied to the edge 8 of the flange 7; this will be discussed in fuller detail below. Plastic is preferably used as the material for the hollow cylindrical part 1. The metal part 10 is injection-moulded into the hollow cylindrical part 1 and is therefore fixedly embedded in the plastic hollow cylindrical part 1. The latching lugs 11 project obliquely out of the metal part towards the flange 7. The hollow cylindrical part 1 is also provided in the region of its flange 7 with the receiving means 12 for a screwdriver, said receiving means 12 here being in the form of a slit. It is, of course, also possible for the respective location to be provided with a recess for a different screwing-in tool, e.g. a hexagon key.

For receiving the stay-bolt 3 in the hollow cylindrical part 1, the hollow cylindrical part 1 is provided with the blind hole 27, into which the stay-bolt projects when the hollow cylindrical part 1 has been fully pressed onto the stay-bolt (see FIG. 1c). In order to facilitate the insertion of the stay-bolt 3 into a penetration (not visible in FIG. 1) in the metal part 10, the blind hole 27 is provided at the end of the hollow cylindrical part 1 opposite the flange 7 with an insertion taper 28, which, when the end of the stay-bolt 3 makes contact, guides said end into the penetration in the metal part 10 and thus into the blind hole 7. The metal part 10 with its penetration 29 is presented in FIG. 8.

In order to connect the structural element 2 to the component 6, the hollow cylindrical part 1 is pressed onto the stay-bolt 3, FIG. 1b first showing a transitional position in which the flange 7 with its edge 8 is just touching the surface 13 of the structural element 2 opposite the panel 6. As can be seen, the latching lugs 11 engage the threads of the stay-bolt 3, thereby securing the position of the hollow cylindrical part 1 with respect to the structural element 2. The hollow cylindrical part 1 can either be pressed straight onto the stay-bolt 3, the latching lugs 11 ratcheting over the threads of the stay-bolt 3, or the hollow cylindrical part 1 can be screwed in, for example using a screwdriver, the latching lugs 11 guiding the hollow cylindrical part 1 along the stay-bolt 3 towards the component 6.

FIG. 1c shows the same arrangement in its final position, the hollow cylindrical part 1 having been pressed fully onto the stay-bolt 3. The hollow cylindrical part 1 pushes with its end 14 opposite the flange 7 onto the inwardly projecting collar 15 of the structural element 2, this completing the pressing-in movement of the hollow cylindrical part 1. In this position, the collar 15 and therefore the structural element 2 are firmly pressed against the component 6, the latching lugs 11 preventing the hollow cylindrical part 1 and the structural element 2 from sliding back. Consequently, the structural element 2 is securely attached to the component 6 with the aid of the hollow cylindrical part 1 and the stay-bolt 3.

With the hollow cylindrical part 1 in the position shown in FIG. 1c, the flange 7 has just been stretched and is pressing resiliently against the surface 13 of the structural element 2. For the operator, this gives the flange 7 a clearly visible and different shape compared with the shape of the flange 7 as shown in FIGS. 1a and b, this clearly indicating to the operator that, owing to the fact that the flange 7 is now pressed flat, the structural element 2 has finally been secured to the component 6, the edge 8 of the flange 7 ensuring a certain degree of sealing between flange 7 and structural element 2.

Owing to the material-induced spring tension of the flange 7 in the position shown in FIG. 1c, a certain pulling effect is exerted on the hollow cylindrical part 1, pulling it away from the stay-bolt 3. This pulling effect is used, where appropriate, to indicate a defective weld in that, under the spring tension of the flange 7, the welding stud is pulled away from the component 6 by the latching lugs 11, whereby the flange 7 again assumes a curved position as shown in FIGS. 1a and b. This would immediately indicate to the operator that the securing of the structural element 2 has not taken place in the required manner, thereby indicating that a defect has occurred in the making of the connection.

A different manner of introducing the metal part 10 into the hollow cylindrical part 1 consists in inserting the metal part 10 into a radial slit 9 in the hollow cylindrical part 1. Such a design is presented in FIG. 2, the position of the hollow cylindrical part 1 with respect to the stay-bolt 3 being identical to that shown in FIG. 1a. As can be seen from FIG. 2, the metal part 1 is seated in the slit 9 with a certain degree of clearance. It is inserted into the hollow cylindrical part 1 through a lateral opening of the slit 9 in the hollow cylindrical part 1.

When welding studs are being welded on, experience shows that it is repeatedly the case that said welding studs are welded on at a slightly oblique angle with respect to their subsurface (see FIG. 3), this representing a problem for many securing means. With the device according to the invention, allowance is made for such a situation in that the metal part 10 is able to use its clearance in the slit 9, which is wider than the thickness of the metal part 10. The tilted position assumed by the metal part 10 compensates for the oblique position of the stay-bolt 3, this in turn guaranteeing the secure attachment of the structural element 2 to the component 6.

FIG. 4 presents a variation on the arrangement according to the aforementioned drawings, the metal part 10 in this case being provided with latching lugs 16 of different lengths, which, because of their different lengths, clawingly engage the threads of the stay-bolt 3 particularly effectively.

FIG. 5 presents a further possibility for tolerance compensation when attaching the device according to the invention, the hole 4 surrounding the hollow cylindrical part 1 with particularly large clearance. The hollow cylindrical part 1 is therefore able to move inside the structural element 2, this allowing an asymmetrical position of the structural element 2. This is also made possible by a correspondingly large through-hole 17 in the region of the collar 15 of the structural element 2. As can be seen, the stay-bolt 3 is asymmetrically positioned in the through-hole 17, this correspondingly compensating for the tolerance.

FIG. 6a presents a further variation on the device shown in FIG. 1, a sealing lip 18 being provided on the base 19 of the collar 15. The sealing lip 18 extends in ring-like manner around the structural element 2. As shown in FIG. 6a, the hollow cylindrical part 1 has been pressed approximately one-third of the way onto the stay-bolt 20, the sealing lip 18 still being in an inclined position. The stay-bolt 20 is here in the form of a smooth cylindrical stud 20.

FIG. 6b presents the arrangement from FIG. 6a with the hollow cylindrical part 1 in its fully pressed-on position, the sealing lip 18 being tightly pressed against the component 6.

FIG. 7 presents the arrangement from FIG. 1 with an addition, which consists in that the device is provided with means for acoustic insulation. Used in this case as acoustic insulation in the region of the slit 9 is an insulation material 21 surrounding the metal part 10, wherein said insulation material 21 may be, for example, a rubber-like material. Furthermore, inserted between the base 19 of the structural element 2 and the component 6 is an acoustic insulation washer 22, which may likewise be of a rubber-like material. Otherwise the operating principle of the device shown in FIG. 7 is identical to that of the device shown in FIG. 1, it additionally being pointed out that, in the embodiment shown in FIG. 7, the stay-bolt 23 is provided with circumferential grooves 24.

FIG. 8 shows the arrangement from FIG. 1 with a further addition, namely a latching means for the captive connection of hollow cylindrical part 1 and structural element 2. Said latching means consists here of a conically extending ring 25 which issues diagonally outwards from the hollow cylindrical part 1 and which is situated behind a bead 26 on the upper opening of the structural element 2. Owing to the elasticity of the ring 25, the hollow cylindrical part 1 is readily able to be pressed into the interior of the structural element 2, the ring 25 jumping over the bead in order then to position itself behind the bead 26, thereby guaranteeing a captive connection between the two parts 1 and 2.

FIG. 9 shows the metal part 10 on its own, said metal part 10 having the penetration 29, from which the latching lugs 11 project in an obliquely upwards direction. The square form of the metal part 10 guarantees the anti-rotation function of the metal part 10.

The embodiment of the device according to the invention as presented in FIGS. 10a, b and c comprises basically the same components. However, the flange 30 is of flat design. Furthermore, the side of the hollow cylindrical part 1 opposite the flange 30 is provided with two spring elements 31 and 32 forming the spring portion, said spring elements 31 and 32 being able, as shown in particular in FIG. 10c, to be pressed against the edge of the hollow cylindrical part 1.

FIG. 10a shows the device in a position in which the hollow cylindrical part 1 is positioned prior to being pressed onto the stay-bolt 3. As for the rest, reference is made in this regard to the explanatory remarks given with respect to FIGS. 10a, b and c.

In FIG. 10b the hollow cylindrical part 1 has been pressed so far into the structural element 2 that the spring elements 31 and 32 are touching the collar 15 of the structural element 2.

FIG. 10c shows the device in a position in which the hollow cylindrical part 1 is fully pressed in, the spring elements 31 and 32 being tightly in contact with the respective edge of the hollow cylindrical part 1, the flange 30 at the same time being in contact with the surface 13 of the structural element and therefore indicating that the hollow cylindrical part 1 has been fully pressed into the structural element 2.

FIG. 11 presents a combination of the designs shown in FIG. 1 and FIG. 10. In this case, the hollow cylindrical part 1 is provided with a curved flange 7, as shown in FIG. 1. In addition, the hollow cylindrical part 1 is provided on its side opposite the flange 7 with the spring elements 31 and 32, which are identical with regard to design and function to the same spring elements as shown in FIG. 10a, b and c, with the consequence that reference can be made to the explanatory remarks given with respect to FIGS. 10a, b and c with regard to the attachment of said spring elements.

1. Device for securing a structural element (2) provided with a hole (4) to a panel-like component (6), said panel-like component (6) being fitted with a stay-bolt (3, 20) onto which can be pressed on the side opposite the component (6) a hollow cylindrical part (1) with a flange (7), said hollow cylindrical part (1) being able to be received by the hole (4) and having a latching portion, the flange (7) having a diameter greater than the diameter of the hole (4), characterized in that a metal part (10), forming the latching portion and having a plurality of latching lugs (11), is inserted into the hollow cylindrical part (1), wherein the hollow cylindrical part (1) has a spring portion (7; 31, 32) which yields to axial pressure and the structural element (2) is provided on its side facing the component (6) with an inwardly directed collar (15) on which rests the hollow cylindrical part (1) with its end opposite the flange (7) when the hollow cylindrical part (1) is in the secured position with the spring portion pressed in.

2. Device according to claim 1, characterized in that the hollow cylindrical part (1) has a radial slit (9) into which the metal part (10) is inserted.

3. Device according to claim 2, characterized in that the slit (9) is of such an oversize in relation to the thickness of the metal part (10) that the metal part (10) is able to assume a tilted position which compensates for an oblique position of the stay-bolt.

4. Device according to claim 2, characterized in that the metal part (10) has an anti-rotation means in the slit (9).

5. Device according to claim 1, characterized in that the latching lugs (11) are of different lengths.

6. Device according to claim 1, characterized in that both the hollow cylindrical part (1) and also the stay-bolt (3, 20) are surrounded with clearance by the hole.

7. Device according to claim 1, characterized in that the structural element (2) is provided on its side facing the component (6) with a sealing lip (18).

8. Device according to claim 1, characterized in that the flange (7) has a receiving means (12) for a screwing-in tool.

9. Device according to claim 1, characterized in that both the structural element (2) and also the hollow cylindrical part (1) have an acoustic insulation (21, 22).

10. Device according to claim 1, characterized in that the stay-bolt (20) has a smooth cylindrical surface.

11. Device according to claim 1, characterized in that the stay-bolt has circumferential grooves (23).

12. Device according to claim 1, characterized in that the hollow cylindrical part (1) is captively secured to the structural element (2) by a latching means (25).

13. Device according to claim 1, characterized in that the spring portion is in the form of a resiliently yielding bulge of the flange (7).

14. Device according to claim 1, characterized in that the hollow cylindrical part (1) is provided on its side opposite the flange (7) with one or more spring elements which force the hollow cylindrical part (1) away from the structural element (2).
